(19) United States
(12) Patent Application Publication
(10) Pub. No.: US 2014/0014249 A1
(43) Pub. Date: Jan. 16, 2014

(54) PARYLENE COATING OF A TIRE COMPONENT

(71) Applicant: Brian R. Bergman, Simpsonville, SC (US)

(72) Inventor: Brian R. Bergman, Simpsonville, SC (US)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 14/008,351

(22) PCT Filed: Mar. 31, 2011
(86) PCT No.: PCT/US11/30758

§ 371 Date: Sep. 27, 2013

(51) Int. Cl. B60C 5/02

(52) U.S. Cl. CPC B60C 1/0008
USPC 152/511; 152/510; 427/393.5; 428/12

(57) ABSTRACT

Embodiments include inflatable articles that include an interior surface adapted for being in contact with the inflation gas, the interior surface coated with a parylene barrier. The parylene barrier may be formed of parylene N, parylene C, parylene D, another substituted parylene or combinations thereof. In particular embodiments, the inflatable article is a tire. Other embodiments include inflatable articles having composite layers, wherein at least two of the composite layers include surfaces that interface with one another and a parylene coating applied to at least one of the interfacing surfaces.

### BACKGROUND OF THE INVENTION

1. Field of the Invention

This invention relates generally to coated rubber articles and more particularly, to tire components coated with a thin barrier layer.

2. Description of the Related Art

Various articles such as tires are constructed to hold air or other gas under pressure. Often these articles are made from a polymeric material having some elastic properties but typically also remain slightly permeable to gases. If left unchecked, the gas permeability of the inflated article will cause the article to deflate over time.

It is therefore often advantageous for inflatable articles to contain a barrier layer that reduces gas permeability and inhibits oxygen travel through the article. For tires, the barrier layer if often an inner tube or an inner liner made of a material that better retains the inflation gas. Rubbery copolymers containing a majority of isobutylene units, such as butyl rubbers, are well known for their ability to retain inflation gas over other materials and are therefore particularly desired for use as inner tubes and tire inner liners.

In tire applications, the inner liner increases the weight of the tire and increases the rolling resistance of the tire so there is a need to decrease the thickness of the inner liner or to eliminate it entirely. The tire industry still strives, therefore, to find materials having improved properties for the manufacture or replacement of inner tubes and inner liners.

### SUMMARY OF THE INVENTION

Particular embodiments of the present invention include articles that are inflatable with an inflation fluid and include an interior surface adapted for being in contact with the inflation gas, the interior surface coated with a parylene barrier. The parylene barrier may be formed of parylene N, parylene C, parylene D, another substituted parylene or combinations thereof. In particular embodiments, the inflatable article is a tire.

The parylene coating may be between 0.5 microns and 100 microns thick and may, in particular embodiments, be applied to the interior surface either before the elastomeric substrate is cured or after the substrate is cured.

Particular embodiments of the present invention include an article that is inflatable with an inflation gas that includes composite layers, wherein at least two of the composite layers include surfaces that interface with one another and a parylene coating applied to at least one of the interfacing surfaces. In embodiments that include a tire, particular embodiments provide that one or more of the interfacing surfaces having the parylene coating may be an inner surface of a rubber skimmed cords assembly of the tire, an outer surface of an inner liner of the tire or combinations thereof, wherein the inner surface of the rubber skimmed cords assembly interfaces with the outer surface of the inner liner of the tire.

Particular embodiments of the present invention include a method for forming an inflatable article that includes forming a parylene coating on an elastomeric substrate, wherein the elastomeric substrate is an interior surface of the inflatable article adapted for being in contract with the inflation gas, an interfacing surface between two composite layers forming at least a portion of the article or combinations thereof. The method may further include the step of curing the elastomeric substrate after the step of forming the parylene coating and/or curing the elastomeric substrate before the step of forming the parylene coating.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a cutaway perspective view of an exemplary pneumatic tire showing many different layers of materials.

### DETAILED DESCRIPTION OF PARTICULAR EMBODIMENTS

Particular embodiments of the present invention include inflatable articles having a surface that is coated with a parylene barrier; such surface being, for example, an interior surface of the inflatable article. The interior surfaces of inflatable articles may be those that are adapted for being in contact with the inflation fluid, such fluids being, for example, air and/or nitrogen. Optionally, for articles that are composites of layers of materials, the interior surface that is coated with parylene may be one or more of the surfaces of the composite layers that interface with one another.

Other exemplary embodiments may include a tire as an inflatable article having an interior surface formed by the inner liner of the tire, the inner liner being coated with a parylene barrier. Other inflatable articles may include inner tubes for tires, sports balls, e.g., basketballs, soccer balls and tennis balls, inflatable rafts, inflatable mattresses and so forth. Methods of making such articles are also included as embodiments of the present invention.

When incorporated with a wall of an inflatable article, a barrier layer reduces the gas and/or vapor permeability of the article and thereby not only improves the performance of the article by inhibiting gases from leaking out of the article, but also may protect the article from other damage, e.g., oxidation due to oxygen migration. In particular embodiments of the present invention, a separate elastomeric inner liner may be formed on a wall of the inflatable article to provide the interior surface that may be coated with parylene. In other embodiments, where there is no separate inner liner, the parylene coating may itself be the barrier layer by coating an interior surface of the inflatable article, typically such interior surface being an elastomeric substrate adapted for being in contact with the inflation gas. In still other embodiments, the parylene coating may be applied to one or more surfaces that interface with one another in an article comprising composite layers of materials.

Parylene is a well-known material that is often used as a coating in the electronics industry, e.g., as a coating on circuit boards. It is also often used as a coating of medical devices in that industry. The term “parylene” as used herein refers to a polymer belonging to the group of polymers based on substituted or unsubstituted p-xylylene. Parylenes have the repeating structure—(para-CX₂—C₆HₐY₍₄₋ₐ₎—CX₂)ₙ—, wherein X can be the same or different and can be hydrogen or halogen, n is between 10 and 10,000, a is an integer of between 0 and 4 and Y is an aromatic substituent that can be the same or different and can be any inert organic or inorganic group that can normally be substituted on an aromatic ring, e.g., amino, aryl, alkyl, alkenyl, alkoxy, hydroxyl, nitro and so forth and in particular embodiments, is a halogen such as chlorine, bromine, iodine and/or fluorine.

Common parylene polymers include poly(2-chloro-para-xylylene) (“parylene C”, wherein X is hydrogen, a is 3 and Y is chlorine), poly(para-xylylene) (“parylene N”, wherein X is hydrogen and a is 4), and poly(2,5-dichloro-para-xylylene) (“parylene D”, wherein X is hydrogen, a is 2 and Y is chlorine). Another example of an available parylene polymer is PARYLENE HT, available from Specialty Coating Systems of Indiana, wherein X is fluorine and a is 4. Parylene coatings are robust and are described as being effective for many years when exposed continuously to air at 80° C. and, in the absence of air, when exposed to temperatures of 220° C. PARYLENE HT is especially robust at higher temperatures and is described as withstanding continuous exposure to air at 350° C.

Parylene, parylene N, parylene C, and parylene D are generic terms for the above described polymers. PARYLENE HT is not a generic term for the polymer described above as it is a registered trademark of Specialty Coating Systems. A substituted parylene is defined herein as a parylene wherein at least one X, at least one Y or combinations thereof include a constituent other than hydrogen. For example, PARYLENE HT is a substituted parylene because the two appended methane groups are replaced with two CF₂ groups, i.e., the X includes fluorine instead of hydrogen.

Parylene polymers are formed from a dimer in a process that includes vaporization of the dimer and then pyrolysis of the vapor dimer resulting in the cleavage of the two methylene-methylene bonds to yield the stable monomeric diradical. The vaporized activated monomer then enters a deposition chamber where the material spontaneously polymerizes onto the substrate. Exemplary vacuum deposition systems are available from Specialty Coating Systems. Advantageously the deposition takes place in the deposition chamber at near ambient temperature. Particular embodiments may include, while not delimitative of the invention, vaporizing the dimer at about 150° C., pyrolyzing the dimer vapor at about 680° C. and depositing the parylene on the substrate in the deposition chamber at a pressure of between 0.01 mm of Hg and 10 mm of Hg.

The deposition of the parylene may be controlled to yield a parylene coating on the substrate of any desirable thickness by, for example, adjusting the time period the surface is exposed inside the deposition chamber. The thickness is not particularly limited and can be any suitable thickness for a particular purpose that reduces the permeability of the surface to the passage of the inflation fluid. In particular embodiments, for example, the parylene barrier coating on each surface may have a thickness of between a minimum thickness and a maximum thickness that can be selected from any of the following list of minimum and maximum thicknesses. Minimum thicknesses for different embodiments may be selected, for example, from 0.5 microns, 1 micron, 2 microns, 3 microns, 4 microns, 5 microns, 6 microns, or 7 microns. Maximum thicknesses for different embodiments may be selected, for example, from 100 microns, 90 microns, 80 microns, 70 microns, 60 microns, 50 microns, 40 microns, 30 microns, 20 microns, 10 microns and 5 microns.

Therefore, a particular embodiment may have a parylene thickness of between 5 microns and 60 microns having selected 5 microns from the list of minimum thicknesses and 60 microns from the list of maximum thicknesses. Thickness measurements may be measured by known means such as, for example, use of a standard laboratory micrometer or by the methods described in ASTM D1005-95, methods for the measurement of dry film thickness of organic coatings.

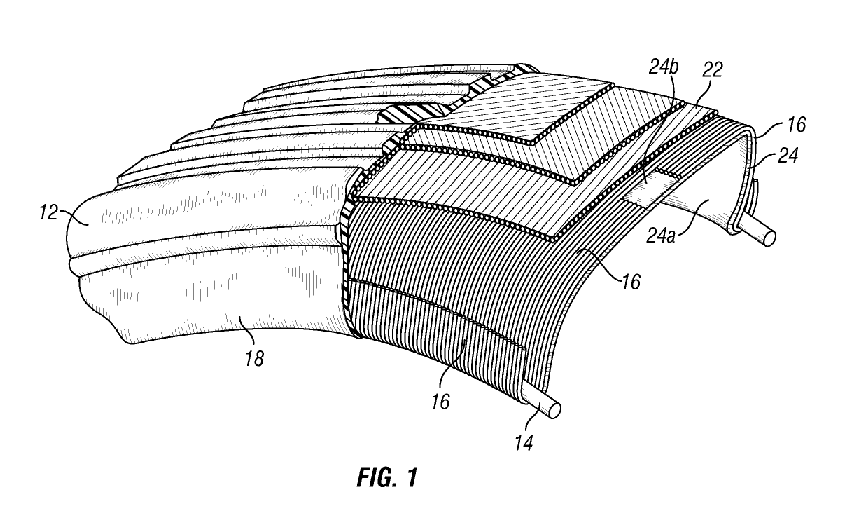

FIG. 1 is a cutaway perspective view of an exemplary pneumatic tire showing many different layers of materials, i.e., the tire comprises a plurality of composite layers. The tire 10 includes the tread 12 that contacts the road and provides traction and good cornering characteristics. The beads 14 are typically nonextensible steel wire loops that anchor the tire 10 onto a wheel with the rubber skimmed cords assembly 16 extending between the two beads 14. The rubber skimmed cords assembly 16 may be made of textile or steel wires that are encased in a layer of calendered rubber (i.e., are encased in a rubber skim) and extend between the beads 14 as the primary reinforcing material of the tire 10. The sidewalls 18 extend between the tread 12 and the beads 14 covering the rubber skimmed cords assembly 16 of the tire and serving to protect the cords from damage due to side scuffing as well as assisting in tread 12 support. The belts 22 are layers of steel wire or textile positioned between the tread 12 and the rubber skimmed cords assembly 16 and serve to stiffen the casing and provide better wear and handling response.

The inner liner 24 is typically made of a butyl rubber based material that helps retain the inflation gases inside the tire 10. The inner liner 24 has an inner surface 24a that is in contact with any inflation gases and an outer surface 24b that is shown positioned against the inner surface of the rubber skimmed cords assembly 16. As used herein, the inner surface of any tire component is the surface closest to the inside of the tire, i.e., towards the inner surface 24a of the inner liner 24. Another example of interfacing surfaces in the tire 10 is the interface between the inner surface of the sidewall 18 and the outer surface of the rubber skimmed cords assembly 16.

An exemplary conventional tire manufacture process involves the following steps: natural and synthetic rubber products are combined with other chemical products such as fillers, curatives, antioxidants and so forth. In combination with the textile and/or metallic cords, the chemical components are subjected to various semi-finishing processes, such as extrusion and calendering. Examples of such semi-finished products include the inner liner and the rubber skimmed cords, which are the cords encased in the rubber skim. These semi-finished products are assembled on a tire building drum or drums and the subsequent uncured tires are cured under pressure and at an elevated temperature in a curing press. Different versions of this manufacturing process are well known to those having ordinary skill in the art but typically they include assembling the semi-finished products into an uncured tire and then curing the tire.

A parylene coating as described above may be deposited onto one or more of these tire/semi-finished product surfaces during any of several steps of the tire manufacturing process to provide a parylene coating on the surface in accordance with various embodiments of the present invention. Alternatively, the parylene coating may be deposited onto one or more surfaces of the cured tire—albeit not on interfacing surfaces of the composites making up the tire since such surfaces would not be exposed in the deposition chamber.

It has been determined that a very thin coating of parylene on the inner surface of a tire, such as a parylene coating on the inner surface 24a of the inner liner 24, can significantly reduce the amount of oxygen that may escape through the walls of the inflated tire. The reduction of the flow of oxygen through the tire wall protects the tire by keeping it at its proper inflation pressure as well as diminishing the oxidation of other parts of the interior of the tire that may come into contact with such oxygen. It also provides an opportunity to reduce the thickness of the inner liner or remove the inner liner altogether resulting in decreased tire weight and decreased rolling resistance of the tire without the penalty of increased inflation gas leakage through the tire walls. In particular embodiments, with the inner liner eliminated from the tire, a parylene coating may be applied as detailed above to the inner surface of the rubber skimmed cords assembly.

Thus, in particular embodiments, the parylene coating may be applied to the inner surface and/or the outer surface of the rubber skimmed cords assembly before the tire is assembled or, if no inner liner is included in the tire product, after the tire is assembled. In embodiments having no inner liner, the parylene may be applied to the rubber skimmed cords of the assembled tire either before the tire is cured or, in other embodiments, after the tire is cured. If applied before the tire is cured, then the inner surface and/or the outer surface of the rubber skimmed cords assembly may be coated with the parylene barrier.

Likewise, the inner liner may be coated with the parylene barrier on the inner surface and/or the outer surface if the coating is applied before curing. If applied after curing, then only the inner surface can be coated as the outer surface would not be accessible in the deposition chamber.

In particular embodiments both the inner and outer surfaces may be coated with the parylene barrier to provide a thinner coating at each surface but still provide the effectiveness of an overall thicker coating when considering the thickness of both the inner and outer coatings.

In some embodiment, a tire may be produced that includes an inner liner with little or no butyl rubber. Inner liners are typically manufactured with at least some butyl rubber because of its ability to block migration of the inflation gases. However, butyl rubber increases the rolling resistance of the tire because of its high hysteresis. With the parylene coating on a rubber substrate, an inner liner may still be included in the tire but made of a material characterized as having lower hysteresis without giving up the ability of the inner liner to effectively block the migration of the inflation gases.

Many types of elastomeric compositions may be used as substrates for coating with parylene. In addition to the butyl rubbers, which include halogenated butyl rubbers, elastomeric compositions may include diene elastomers. Diene elastomers or rubber is understood to mean those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol. %.

Thus, for example, diene elastomers such as butyl rubbers, nitrile rubbers or copolymers of dienes and of alpha-olefins of the ethylene-propylene diene terpolymer (EPDM) type or the ethylene-vinyl acetate copolymer type do not fall within the preceding definition of essentially unsaturated diene elastomers or rubbers, and may in particular be described as “essentially saturated” diene elastomers or rubbers (low or very low content of units of diene origin, i.e., less than 15 mol. %). Particular embodiments of the present invention may include essentially saturated diene elastomers and/or essentially unsaturated diene elastomers. As previously noted, butyl rubbers are commonly used in rubber compositions for inner liners of tires.

Within the category of essentially unsaturated diene elastomers are the highly unsaturated diene elastomers, which are understood to mean in particular diene elastomers having a content of units of diene origin (conjugated dienes) that is greater than 50 mol. %.

The rubber elastomers that are highly unsaturated diene elastomers include, for example, polybutadienes (BR), polyisoprenes (IR), natural rubber (NR), butadiene copolymers, isoprene copolymers and mixtures of these elastomers. The polyisoprenes include synthetic cis-1,4 polyisoprene, which may be characterized as possessing cis-1,4 bonds at more than 90 mol. % or alternatively, at more than 98 mol. %.

Other highly unsaturated rubber elastomers include copolymers such as, for example, butadiene-styrene copolymers (SBR), butadiene-isoprene copolymers (BIR), isoprene-styrene copolymers (SIR) and isoprene-butadiene-styrene copolymers (SBIR) and mixtures thereof.

The elastomeric substrates having a parylene coating as described in particular embodiments herein may be formed of rubber compositions that include one or more of the rubber components described above as well as compounding components that are known to one having ordinary skill in the art. Compounding components may include, for example, fillers such as carbon black and/or silica incorporated into the rubber composition. Other fillers may also be useful such as clays and/or other platy fillers. Other exemplary compounding components may include some or all of the following: antidegradants, antioxidants, fatty acids, waxes, stearic acid, zinc oxide and other accelerators. Examples of antidegradants and antioxidants include 6 PPD, 77 PD, IPPD and TMQ and may be added to rubber compositions in an amount of from 0.5 and 5 phr. Zinc oxide may be added in an amount of between 1 and 6 phr or 2 and 4 phr. Waxes may be added in an amount of between 1 and 5 phr.

Curing systems based on the use of sulfur or peroxide may be included in the rubber compositions. Accelerators may be included in rubber compositions to control the time and/or temperature required for vulcanization and to improve the properties of the cured rubber composition. Combinations of accelerators are often useful to improve the properties of the cured rubber composition and the particular embodiments include the addition of secondary accelerators.

As in the case of tire inner liners and the rubber skimmed cords, desirable substrates for the parylene coating include flexible and/or elastomeric substrates. Examples include balloons, dirigibles, tires for automobiles, trucks bicycles, farm equipment and so forth, inflatable mattresses, sports balls and so forth.

The invention is further illustrated by the following examples, which are to be regarded only as illustrations and not delimitative of the invention in any way.

### EXAMPLE 1

Samples of a cured butyl rubber composition typical of a composition that is used in an inner liner were prepared. The rubber composition included bromobutyl rubber, carbon black (N772), a tackifier resin and a sulfur cure system. The cured samples were 150 mm square by 1 mm thick. All surfaces were exposed in a parylene deposition chamber and coated with parylene C. The samples were then tested to determine their oxygen permeability.

Oxygen permeability was measured using a MOCON OX-TRAN 2/60 permeability tester at 40° C. The cured samples were mounted on the instrument and sealed with vacuum grease with 10 psig of nitrogen on one side of the disk and 10 psig of oxygen on the other side. Using a Coulox oxygen detector on the nitrogen side, the increase in oxygen concentration was monitored. The time required for oxygen to permeate through the disk or for the oxygen concentration on the nitrogen side to reach a constant value, was recorded and used to determine the oxygen permeability.

Table 1 provides the results of the oxygen permeability tests. The witness sample (W1) was not coated with parylene while the three other samples (F1, F2, F3) were coated with the parylene C. Each exposed surface of the samples was coated with parylene C to the thickness shown in Table 1. As shown in the table, as the parylene coating thickness increased, a significant increase in the permeability improvement was realized.

TABLE 1
Permeability Results

| | W1 | F1 | F2 | F3 |
|---|---|---|---|---|
| Parylene C Thickness, microns | 0 | 3.3 | 10.2 | 21.2 |
| Permeability, cc-mm/(m²-day) | 145 | 96 | 66 | 42 |
| Permeability Improvement, % | 0 | 34 | 54 | 71 |

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. An article that is inflatable with an inflation fluid, comprising:
an interior surface adapted for being in contact with the inflation fluid, the interior surface coated with a parylene barrier.

2. The inflatable article of claim 1, wherein the inflatable article is a tire.

3. The inflatable article of claim 2, wherein the interior surface is an inner surface of an elastomeric inner liner.

4. The inflatable article of claim 2, wherein the interior surface is an inner surface of a rubber skimmed cords assembly of the tire.

5. The inflatable article of claim 1, wherein the inflatable article is an inner tube for a tire.

6. The inflatable article of claim 1, wherein the parylene barrier is between 0.5 micron and 100 microns thick.

7. The inflatable article of claim 6, wherein the parylene barrier is between 5 microns and 60 microns.

8. The inflatable article of claim 1, wherein the parylene barrier is formed of a substituted parylene.

9. The inflatable article of claim 1, wherein the parylene barrier is formed from parylene N, parylene C, parylene D or combinations thereof.

10. An article that is inflatable with an inflation fluid, comprising:
composite layers, wherein at least two of the composite layers include surfaces that interface with one another;
a parylene coating applied to at least one of the interfacing surfaces.

11. The inflatable article of claim 10, wherein the inflatable article is a tire.

12. The inflatable article of claim 11, wherein one of the interfacing surfaces having the parylene coating is an inner surface of a rubber skimmed cords assembly of the tire, an outer surface of an inner liner of the tire or combinations thereof, and wherein the inner surface of the rubber skimmed cords assembly interfaces with the outer surface of the inner liner of the tire.

13. The inflatable article of claim 12, further comprising an inner surface of the inner liner and a parylene barrier coated on the inner surface of the inner liner.

14. The inflatable article of claim 10, wherein the parylene coating is between 0.5 micron and 60 microns thick.

15. The inflatable article of claim 10, wherein the parylene coating is formed of a substituted parylene.

16. The inflatable article of claim 10, wherein the parylene coating is formed from parylene N, parylene C, parylene D or combinations thereof.

17. A method for forming an inflatable article, comprising:
forming a parylene coating on an elastomeric substrate, wherein the elastomeric substrate is an interior surface of the inflatable article adapted for being in contract with an inflation fluid, an interfacing surface between two composite layers forming at least a portion of the article or combinations thereof.

18. The method of claim 17, further comprising:
curing the elastomeric substrate after the step of forming the parylene coating.

19. The method of claim 17, further comprising:
curing the elastomeric substrate before the step of forming the parylene coating.
